(19) United States
(12) Patent Application Publication
(10) Pub. No.: US 2010/0032224 A1
(43) Pub. Date: Feb. 11, 2010

(54) ROBOT AND MOVING MECHANISM THEREFOR

(75) Inventor: BAO-SHUAI LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/512,999

(22) Filed: Jul. 31, 2009

(30) Foreign Application Priority Data
Aug. 6, 2008 (CN) 200810303558.1

(51) Int. Cl. B25J 5/00

(52) U.S. Cl. 180/218

(57) ABSTRACT

A robot includes a main body and a moving mechanism for moving the main body. The moving mechanism includes a chassis, a pair of wheels, and a supporting unit. The chassis is at a bottom of the main body for assembling the moving mechanism with the main body. The pair of wheels are rotatably and coaxially mounted to the chassis. The supporting unit is pivotally mounted to the chassis. The supporting unit and two wheels are arranged on vertexes of a triangle, and a vertical line passing through the center of gravity of the main body passes through the triangle.

### BACKGROUND

1. Technical Field

The present disclosure relates to robots, and particularly to a moving mechanism for a robot.

2. Description of Related Art

Self propelled robots are generally provided with a moving mechanism such as wheels or caterpillar tracks. Because the wheels have advantages of flexibility and moving speed over the caterpillar tracks, the wheels are widely used on the robots.

A typical robot may include a main body and a pair of wheels attached to the bottom of the main body. The wheels are rotatable to move the main body. However, this two-wheeled moving mechanism is not stable, especially when the robot moves on a rugged surface. For example, when the robot goes over an obstacle, the robot may flip over.

Therefore, an improved moving mechanism for a robot is desired.

Other advantages and novel features will become more apparent from the following detailed description of exemplary embodiments when taken in conjunction with the accompanying drawings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a perspective view of a robot in accordance with an exemplary embodiment.

FIG. 2 is a bottom view of the robot in FIG. 1.

FIG. 3 is a partly exploded view of the robot in FIG. 1.

FIG. 4 is a partly exploded view of the robot in FIG. 1 with an outer boy of the robot removed.

### DETAILED DESCRIPTION

References will now be made to the drawings to describe exemplary embodiments of a robot.

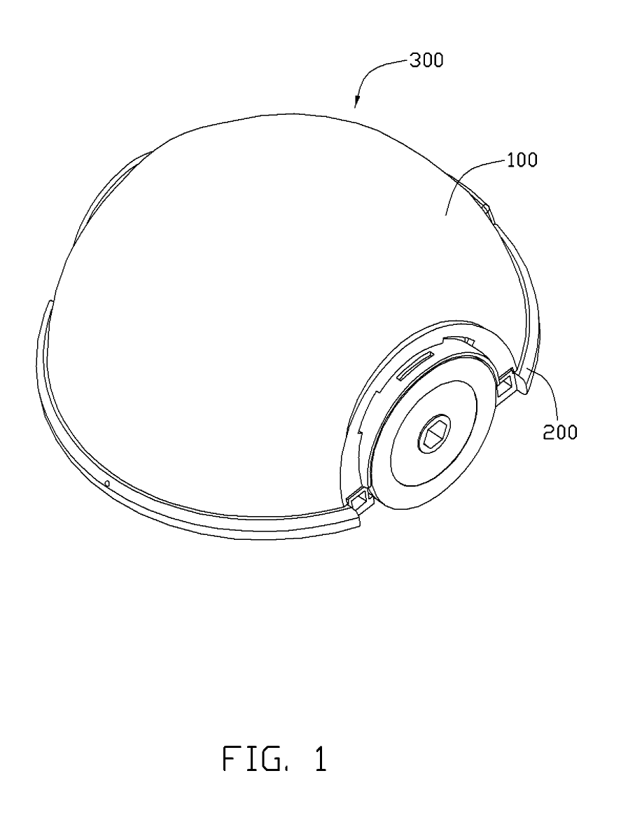

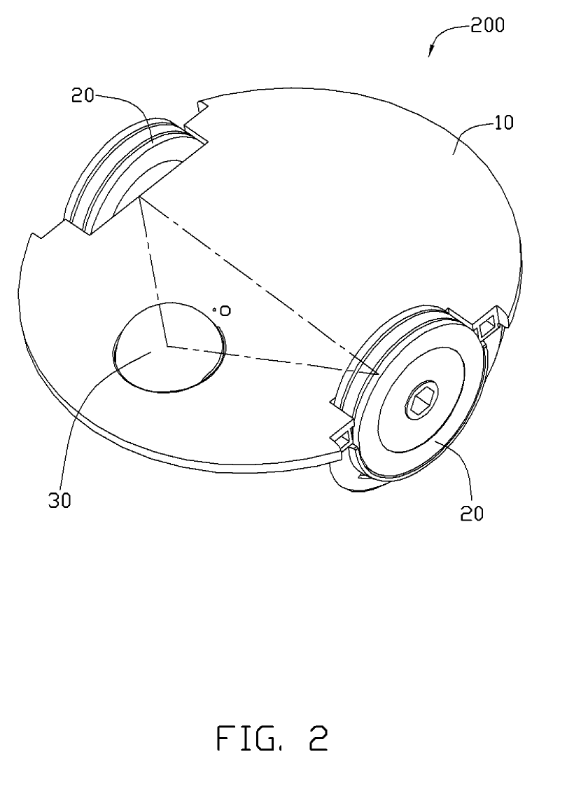

Referring to FIGS. 1, and 2, a robot 300, such as a toy robot, includes a main body 100, and a moving mechanism 200 attached to the bottom of the main body 100 for moving the main body 100. The moving mechanism 200 includes a chassis 10, two wheels 20, and a supporting unit 30. The chassis 10 is mounted to the main body 100 for assembling the moving mechanism 200 with the main body 100. The two wheels 20 are mounted coaxially and rotatably to the chassis 10. A motor (not shown) may be provided on chassis 10 or the main body 100 to drive the wheels 20 to rotate. The supporting unit 30 is pivoted to the chassis 10. The two wheels 20 and the supporting unit 30 are located at three points of a triangle for providing a balance for the motion of the robot 300.

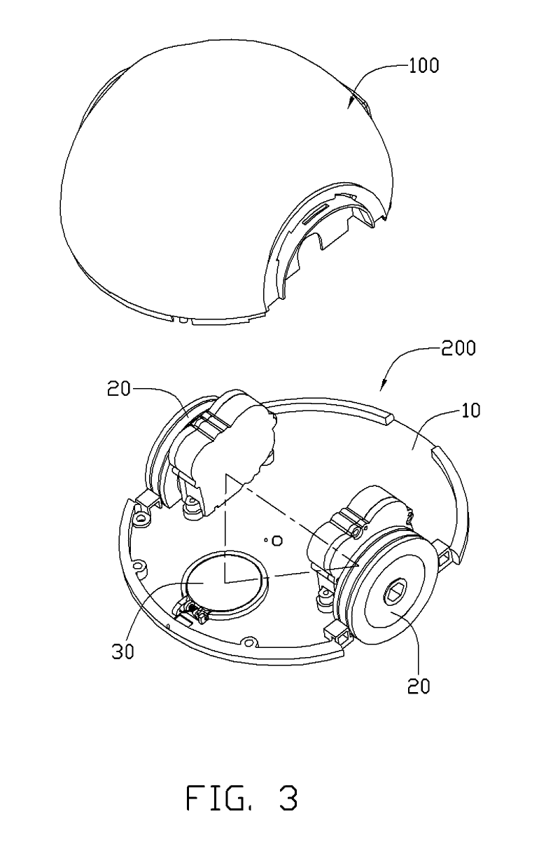

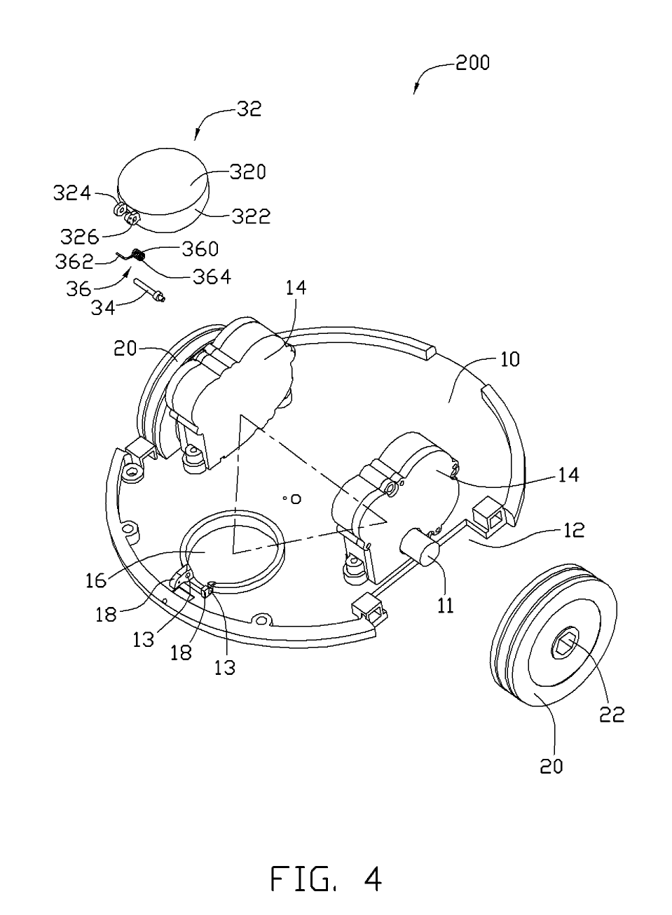

Referring to FIGS. 3 and 4, the main body 100 has an approximate hemispherical shell. The chassis 10 may be an independent part connected to a bottom surface of the main body 100. The chassis 10 may also be integrated with the main body 100 and arranged as a bottom component of the main body 100.

The chassis 10 may be a plate, and defines two notches 12 and an opening 16. The two notches 12 and the opening 16 are arranged on three vertexes of a triangle respectively. The notches 12 are for rotatably receiving the two wheels 20. The opening 16 is for receiving the supporting unit 30. A pair of mounting boards 14 is disposed on the chassis 10 adjacent to the notches 12. From each mounting board 14 a shaft 11, horizontally protrudes, which extends to the corresponding notches 12. The center of the shafts 11 are coaxial with each other. A pair of the fixing blocks 18 is disposed on the chassis 10 adjacent to the opening 16. The fixing blocks 18 are parallel with each other. Each fixing block 18 defines a pivot hole 13. The center of the pivot holes 13 are coaxial with each other. A vertical line passing through the center of gravity of the main body 100 passes through the center of the triangle. Each of the two wheels 20 defines a shaft hole 22 at the center thereof. The shaft 11 is inserted in the shaft hole 22, so as to mount the wheel 20 to the mounting board 14 correspondingly. As such, the two wheels 20 are positioned rotatably in the two notches 12 correspondingly. The diameter of the two wheels 20 are larger than the thickness of the mounting board 10, thus, the two wheels 20 extend out of the opposite sides of chassis 10 in the thickness direction of the mounting board 10, and upwardly support the main body 100 loaded on the chassis 10.

The supporting unit 30 is pivotally mounted on the fixing blocks 18 and installed in the opening 16. At least part of the supporting unit 30 extends downwardly from the opening 16, so that the supporting unit 30 and the two wheels 20 are respectively arranged on the three vertexes of the triangle to upwardly support the main body 100. The supporting unit 30 includes a supporting body 32, a pivot shaft 34 mounting the supporting body 32 to the mounting board 18, and a torsion spring 36.

The supporting body 32 is received in the opening 16. The supporting body 32 may be hemispherically shaped. The supporting body 32 may have a plane 320 and a hemispherical ball 322 bounding the plane 320. Two lugs 324 extend from the hemispherical ball 322 and are adjacent to the plane 320. The lugs 324 are parallel with each other and received between the two fixing blocks 18. Each lug 324 defines a through hole 326 corresponding to the pivot hole 13 of the fixing block 18. The pivot shaft 34 passes through the through holes 326 and the pivot holes 13 to couple the supporting body 32 to the chassis 10. The plane 320 is closest to the chassis 10. The ball 322 extends out of the chassis 10 via the opening 16 for pivotally supporting the main body 100 loaded on the chassis 10. The ball 322 is made of hard material and substantially smooth, thus the ball 322 is wear-resistant and the surface friction coefficient is small.

The torsion spring 36 includes a coil body 360 and two arms 362 and 364 extending from opposite ends of the coil body 360. The coil body 360 is sleeved on the pivot shaft 34, with one arm 362 hooking at one fixing block 18, and the other arm 364 hooking the lug 324 away from that one fixing block 18. As such, the torsion spring 36 is restricted between the fixing block 18 and the supporting body 32.

When the supporting body 32 is subjected to an external force, the supporting body 32 rotates toward the inner portion of the chassis 10, and the torsion spring 36 deforms to generate an elastic action on the supporting body 32. When the external force is released, the supporting body 32 returns to the original state under the effect of elasticity. For example, if the robot 300 stands on a flat surface (not shown), the wheels 20 and the supporting body 32 form three points to contact the floor. Thus, the robot 300 is prevented from falling over by the three points contacting the flat surface. If the robot 300 moves, and the supporting body 32 comes into contact with an obstacle, the supporting body 32 pivots toward the inner portion of the chassis 10 because of the force of the obstacle on to supporting body 32. As such, the supporting body 32 keeps the robot 300 from flipping over.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A robot comprising:
a main body;
a moving mechanism for moving the main body, the moving mechanism comprising:
a chassis at a bottom of the main body for assembling the moving mechanism with the main body;
a pair of wheels rotatably and coaxially mounted to the chassis; and
a supporting unit pivotally mounted to the chassis, the supporting unit and the pair of wheels arranged on vertexes of a triangle, and a vertical line passing through the center of gravity of the main body passing through center of the triangle.

2. The robot of claim 1, wherein the pair of wheels are capable of rotating so as to drive the chassis together with the main body to move, and at least part of the supporting unit extends out of the chassis.

3. The robot of claim 1, wherein the chassis defines two notches for rotatably receiving each wheel of the pair of wheels correspondingly, and an opening, the supporting unit extends out of the chassis via the opening, the two notches and the opening are arranged on the vertexes of the triangle.

4. The robot of claim 3, wherein the supporting unit comprises a supporting body, a pivot shaft pivotally mounting the supporting body to the chassis, and an elastic element restricted between the supporting body and the chassis, the supporting body extends out of the chassis, the supporting body is rotatable toward an inner portion of the chassis and the elastic element is deformed to generate an elasticity when the supporting body is subjected to an external force, the elasticity drives the supporting body to return to the original position when the external force is released.

5. The robot of claim 4, wherein the elastic element is a torsion spring, the torsion spring comprises a coil body and two arms extending from opposite ends of the coil body, the coil body is sleeved on the shaft with one arm hooking at the chassis and the other arm hooking the supporting body.

6. The robot of claim 4, wherein the supporting body comprising a plane and a hemispherical ball bounding the plane, the plane is closest to the chassis.

7. The robot of claim 6, wherein the ball is made of hard material and substantially smooth.

8. The robot of claim 6, wherein a pair of lugs protrude from the hemispherical ball, the lugs are adjacent to the plane, each lug defines a through hole and the center of the through holes are coaxial, a pair of fixing blocks facing each other protrude from the chassis, the fixing blocks is adjacent to the opening, each fixing blocks defines a pivot hole corresponding to the though holes, the lugs are received between the fixing blocks, the pivot shaft passes through the through holes and the pivot hole to pivotally mount the supporting body to the chassis.

9. A moving mechanism for moving a robot main body, comprising:
a chassis for loading the robot main body;
a pair of wheels rotatably and coaxially mounted to the chassis, the pair of wheels being capable of rotating so as to drive the chassis together with the main body to move; and
a supporting unit pivotally mounted to the chassis and at least part of the supporting unit extending out of the chassis that the supporting unit and the pair of wheels are arranged on vertexes of a triangle, the supporting unit further capable of pivoting toward an inner portion of the chassis when contacting with an obstacle, such that the moving mechanism is capable of driving over the obstacle.

10. The moving mechanism of claim 9, wherein the chassis defines two notches for rotatably receiving the pair of wheels correspondingly, and an opening, the supporting unit extends through the chassis via the opening, the two notches and the opening are arranged on the vertexes of the triangle.

11. The moving mechanism of claim 10, wherein the supporting unit comprises a supporting body, a pivot shaft pivotally mounting the supporting body to the chassis, and an elastic element restricted between the supporting body and the chassis, the supporting body extends out of the chassis, the supporting body pivots toward an inner of the chassis and the elastic element is deformed to generate an elasticity when the supporting body is subjected to an external force, the elasticity drives the supporting body to return to the original position when the external force is released.

12. The moving mechanism of claim 11, wherein the elastic element is a torsion spring, the torsion spring comprises a coil body and two arms extending from opposite ends of the coil body, the coil body is sleeved on the shaft with one arm hooking at the chassis and the other arm hooking the supporting body.

13. The moving mechanism of claim 11, wherein the supporting body comprising a plane and a hemispherical ball bounding the plane, the plane is closest to the chassis.

14. The moving mechanism of claim 13, wherein the ball is made of hard material and substantially smooth.

15. The moving mechanism of claim 13, wherein a pair of lugs protrude from the hemispherical ball, the lugs are adjacent to the plane, each lug defines a through hole and the center of the through holes are coaxial, a pair of fixing blocks facing each other protrude from the chassis, the fixing blocks is adjacent to the opening, each fixing blocks defines a pivot hole corresponding to the though holes, the lugs are received between the fixing blocks, the pivot shaft passes through the through holes and the pivot hole to pivotally mount the supporting body to the chassis.

16. A robot comprising:
a main body;
a pair of wheels rotatably and coaxially mounted to the bottom of the main body, the pair of wheels being capable of rotating so as to drive the main body to move; and
a supporting unit pivotally mounted to the main body, and at least part of the supporting unit extending out of the main body that the supporting unit and the pair of wheels are arranged on vertexes of a triangle, the supporting unit further capable of pivoting toward an inner of the main body when contacting with an obstacle hindering the robot from moving.

17. The robot of claim 15, wherein the bottom of the main body defines an opening, the supporting unit extends out of the main body via the opening.

18. The robot of claim 16, wherein the supporting unit comprises a supporting body, a pivot shaft pivotally mounting the supporting body to the main body, and an elastic element restricted between the supporting body and the main body, the supporting body extends out of the main body, the supporting body pivots toward the inner of the main body and the elastic element is deformed to generate an elasticity when the supporting body is subjected to an external force, the elasticity drives the supporting body to return to the original position when the external force is released.

19. The robot of claim 18, wherein the elastic element is a torsion spring, the torsion spring comprises a coil body and two arms extending from opposite ends of the coil body, the coil body is sleeved on the shaft with one arm hooking at the chassis and the other arm hooking the supporting body.

20. The robot of claim 16, wherein the at least part of the supporting unit extending out of the main body is hemispherical shaped and made of hard material and substantially smooth.
